(19) United States
(12) Patent Application Publication
(10) Pub. No.: US 2008/0040659 A1
(43) Pub. Date: Feb. 14, 2008

(54) Markup Language Translator System

(76) Inventor: Stephen Doyle, Bristol (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/588,909

(22) PCT Filed: Feb. 4, 2005
(86) PCT No.: PCT/GB05/00384

§ 371 Date: Oct. 25, 2007

(30) Foreign Application Priority Data
Feb. 5, 2004 (GB) 0402576.3

(51) Int. Cl. G06F 3/00

(52) U.S. Cl. 715/236

(57) ABSTRACT

A method of providing content to be presented on a terminal, said method comprising: taking as an input a first document in a first document language, the first document language using markup tags to define elements of the document, said first document language including a first set of element types, translating the first document into a second document in a second document language, the second document language using markup tags, text or document codings to define elements of the second document, said second document language including a second set of element types, wherein the first set of element types includes a first element type, for which an equivalent element type is not present in said second set, and wherein the first document includes a section including said first element type and at least one attribute of the element type, the method comprising processing said first section in the first document, and generating a corresponding second section in said second document, said second section including a second element type, wherein one of said first section and said second section includes two separate subsections which each include one or more attributes corresponding to one or more attributes of said second or said first element type, respectively.

### FIELD OF THE INVENTION

The present invention relates to a method of providing content to be presented on a terminal using a document browser application, the method comprising taking as an input a first document in a first document browser language, the first document browser language using markup tags to define elements of the document, the first document browser language including a first set of element types, translating the first document into a second document in a second document browser language, the second document browser language using markup tags to define elements of the second document, the second document browser language including a second set of element types. The invention further relates to apparatus and software arranged to carry out the described method.

### BACKGROUND OF THE INVENTION

The enabling of browser content across different types of user terminal device can be problematic, since often different devices have different browser types or versions, each requiring a document to be input in a different document browser language.

One known method for enabling content across different device types are “transcoding” solutions which convert content from one language to another.

The Open Useabilty Interface (OUI) is an open source project which principally focuses on the transcoding part of content creation. Originally OUI was developed within the mobile software company Openwave. The project seems to require each manufacturer's device to have a distinct software implementation of a “rendering engine”, and does not handle generation of content other than the languages WML and XHTML-Mobile Profile.

XMS Stylesheet Translation Language (XSLT) is an XML technology that takes a source file in an XML format, applies a series of translations to it and produces content according to the transformation rules. This is a common technology available with Java Application Server platforms. However, the content author must regenerate their site within an XML format so that XSLT can be applied. To function optimally XSLT files need to be created for every device, device class (where common capabilities) or device variant, therefore authoring XSLT files is relatively intensive process, ant the content author needs to acquire detailed knowledge about devices in order to create XSLT files.

One problem associated with all types of document translation from one document browser language to another is the case in which the target document browser language does not have an element type which is equivalent to an element type in the original content.

It is an object of the present invention to overcome the drawbacks of the prior art.

### SUMMARY OF THE INVENTION

In accordance with one aspect of the present invention, there is provided a method of providing content to be presented on a terminal, said method comprising:

taking as an input a first document in a first document language, the first document language using markup tags to define elements of the document, said first document language including a first set of element types,

translating the first document into a second document in a second document language, the second document language using markup tags, text or document codings to define elements of the second document, said second document language including a second set of element types,

wherein the first set of element types includes a first element type, for which an equivalent element type is not present in said second set, and wherein the first document includes a section including said first element type and at least one attribute of the element type,

the method comprising processing said first section in the first document, and generating a corresponding second section in said second document, said second section including a second element type,

wherein one of said first section and said second section includes two separate subsections which each include one or more attributes corresponding to one or more attributes of said second or said first element type, respectively.

The invention provides for translation of element types between the first and second documents, even where a one-to-one equivalence between the element types does not exist in the two different document browser languages.

In accordance with a feature of the invention, the two separate subsections may be at the same level of hierarchy in the respective document in which they are present.

In accordance with a further feature of the invention, the two different subsections may be at different levels of hierarchy in the respective document in which they are present.

In an embodiment of the invention, said second section includes two separate subsections which each include one or more attributes corresponding to one or more attributes of said first element type.

The second section may include two separate subsections which each include the same attribute, said same attribute corresponding to an attribute of the first element type.

The first section may include a first subsection including a template element and a plurality of further subsections defining parts of a document to be presented separately on the user terminal. The second section may include a plurality of equivalent subsections corresponding to each of said further subsections; said equivalent subsections each including the same attribute, and said same attribute corresponding to an attribute of said template element. The template element type may for example have a hyperlink attribute defined therein, and each of the equivalent subsections may include a corresponding hyperlink attribute.

Alternatively, the second section may include two separate subsections which each include one or more different attributes, said different attributes each corresponding to at least one attribute of said first element type.

This feature of the invention is applicable when said first element type is a form element type.

In the second section produced in the translation of a form element, the two separate subsections of the second section may include a first subsection in which the presentation of input data fields is defined and a second subsection in which an action is defined whereby the data collected in said input data fields is sent a server.

Further features and advantages of the invention will become apparent from the following description of preferred embodiments of the invention, given by way of example only, which is made with reference to the accompanying drawings.

The two separate subsections may be in the first document and the second document may include one section which is equivalent to one of the two separate subsections. The two separate subsections may for example be in a WML document and may include a header element and a card element, respectively. A title attribute may be moved from a card element into a header element in the translated document.

In further embodiments of the invention, the first set of element types includes attributes which do not exist in the second set of element types and wherein the translation is conducted using equivalent expressions using Cascading Style Sheet attributes.

In yet further embodiments of the invention, the first set of element types includes attributes containing Cascading Style Sheet expressions which do not exist in the second set of element types and wherein the translation is conducted using equivalent expressions using element attributes.

In further embodiments of the invention, the first set of element types includes attributes containing Cascading Style Sheet expressions which do not exist in the second set of element attributes and wherein the translation is conducted using equivalent expression using elements and attributes.

In preferred embodiments of the invention, a first set of element types, attributes and document content is converted to a second set of element types, attributes and document content according to specific real-time and pre-determinable capabilities of that device.

During the translation process, the generation of a second document is partitioned into sections to enable operation with devices with limited bandwidth connections or memory limitations. There may be associated with the partitioning the generation of navigational elements allowing a user to select different sections equivalent to those in the first document.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram illustrating the arrangement of a data processing system in accordance with an embodiment of the invention;

FIG. 2 is a schematic diagram illustrating the provision of contents different user terminals; and

FIG. 3 is a flow diagram illustrating steps carried out by a document server in accordance with an embodiment of the invention.

### DETAILED DESCRIPTION OF THE INVENTION

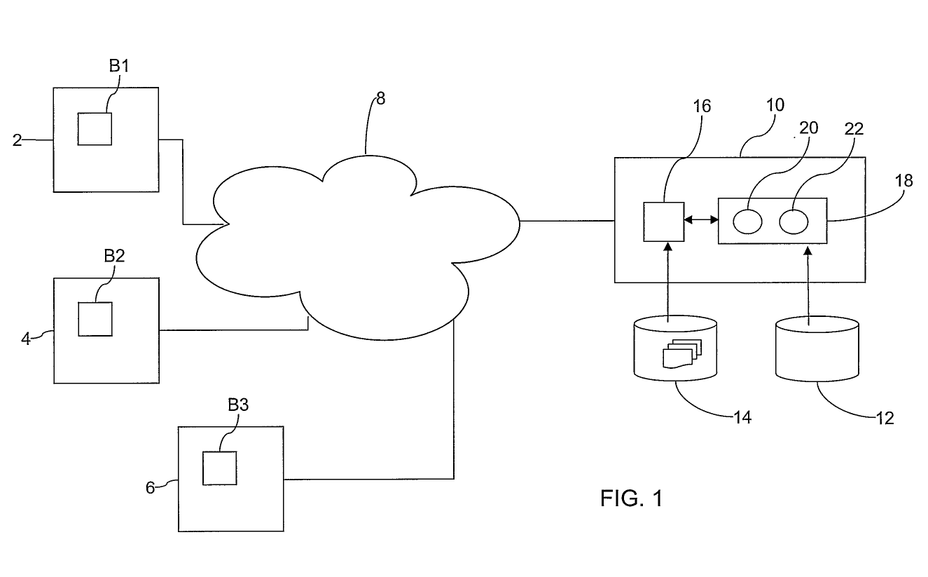

Referring now to FIG. 1, a data processing system in accordance with the present invention includes, for the purposes of illustration, three different user terminals 2, 4, 6, each in the form of, for example, mobile communications devices such as mobile telephones and/or personal digital assistants (PDAs) capable of receiving documents in a mark-up language format and displaying the document on a display screen (not shown). Each terminal 2, 4, 6 includes a data processing function and runs software applications including a document browser B1, B2, B3. Each of the document browsers in the respective user terminals is of a different type, and, in this example, each document browser B1, B2, B3 requires document to be received in a different document browser language in order for the document to be successfully displayed in the respective device. Each respective user terminal 2, 4, 6 is connected by means of data links to a data communications network 8, such as the Internet, and, via the data communications network 8, to a document server 10.

The document server 10 is, in this embodiment, a Java Server Pages engine. The document server 10 has access to a device capability database 12 and a store of original content files 14. Within the document server 10, a servlet engine 16 interacts with the browsers B1, B2, B3 on the user terminals 2, 4, 6 by receiving requests and responding thereto appropriately. The system of the present invention also includes a Java Server Pages (JSP) tag library 18 containing a set of tag handlers 20 and a device renderer 22.

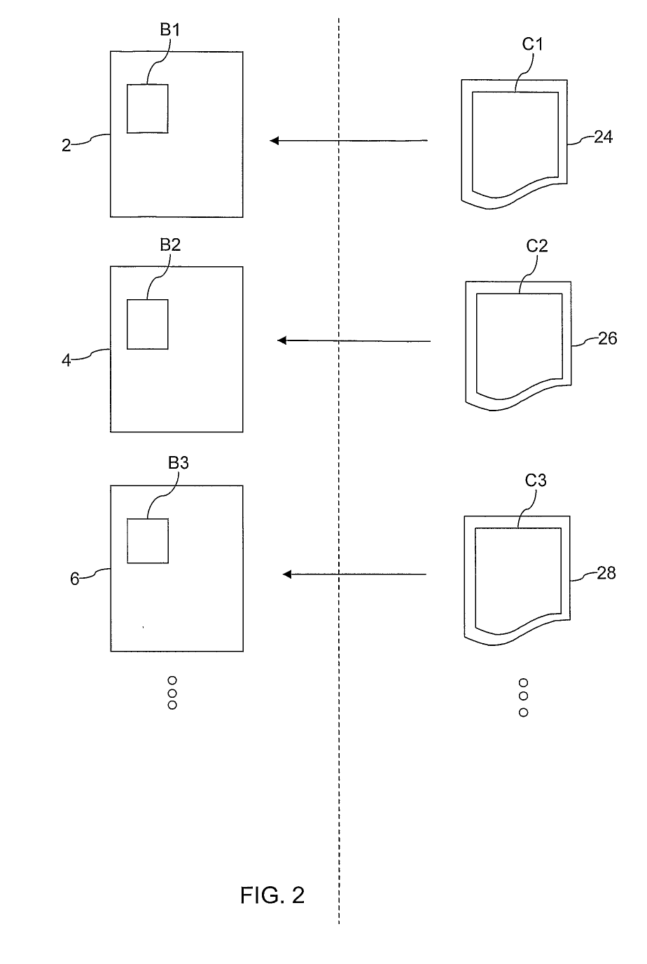

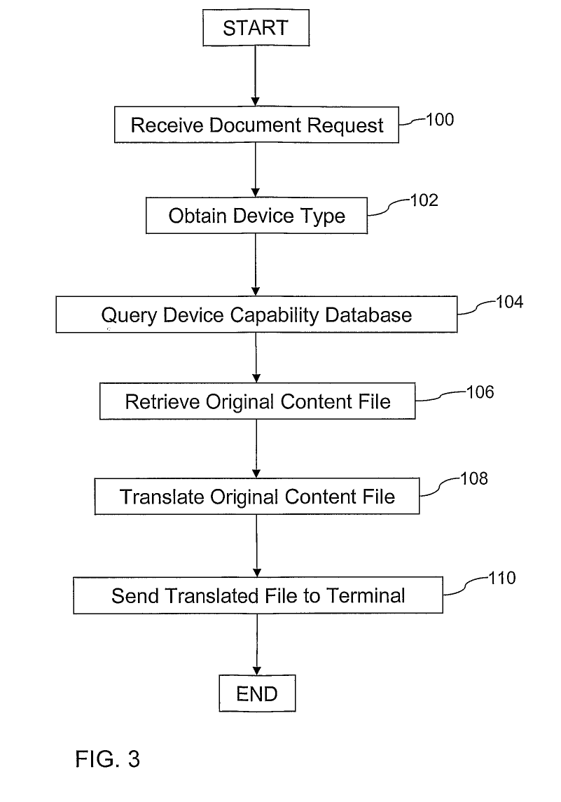

FIG. 2 illustrates the basic principle of the present invention, insofar as each of the different user terminals 2, 4, 6 running different browser applications B1, B2, B3 accepts documents 24, 26, 28 in different document formats. In particular, each respective document 24, 26, 28 includes a differently formatted content C1, C2, C3, coded in a different document language which is compatible with the relevant document browser. In order to provide all of these different content types C1, C2, C3 from a single original content file stored in content store 14, the document server 10 conducts dynamic document translation as illustrated in FIG. 3.

Referring to FIG. 3, the document server 10, on receiving a document request, step 100, from a selected device 2, 4, 6, first obtains the device type, step 102. The device type may be contained within the initial document request, or may be specifically requested in response to the initial document request. On receiving a device type indication, the device renderer 22 is used to query the device capability database 12 in order to determine the corresponding document language type(s) which the device supports. Next, the original content file is retrieved from the content store 14. If the original content file is not in one of the languages which the device supports, the document server engine conducts translation of the original content file, step 108, using the tag handlers 20 in the JSP tag library 18. Once the document is translated, the translated file is transmitted to the requesting terminal, step 110.

The document server system of the present invention, referred to as the Mobiliser™ solution herein, dynamically delivers content to mobile devices and personal digital assistants (PDA's) which has been optimised according to the device capabilities. In the world of mobile devices and PDA's (unlike in desktop web access) there are huge variations in device capabilities and usable markup languages and this makes authoring for pages extremely difficult, costly and time consuming. The mobiliser solution has been developed to hide away all of this complexity in an easy to use software component.

The mobiliser solution has been developed to work within a Java Application Server environment where Java Server Pages (JSP) is a key technology by which web designers create dynamic web sites. A dynamic web site is used for all but the most trivial web sites as it allows the end user to interact with the web site in more interesting ways for example allowing online searches, electronic commerce and applications involving database accesses. For the mobiliser solution JSP is a key technology enabler for dynamic interaction between the end user device and the web server.

JSP technology allows the simple mixing of HTML markup tags and page content along with Java based programming capabilities. This allows a page designer to primarily work with standard HTML and page design features whilst having easy access to programming capabilities when needed for example in accessing databases.

The mobiliser solution builds on a complementary JSP technology called Java Serverpages Tag Library (JSTL). JSTL allows the building of custom functionality that is easily used through “markup tags”. Markup tags follow a structure similar to the HTML markup language making it easy for web page designers to adapt to a more functionally rich environment.

JSTL tags can provide powerful functionality to a web page designer through a simple interface which borrows significantly from familiar HTML page design. JSTL tags can encompass simple or complex software functionality that is accessed very simply using page markup tags.

The mobiliser solution encompasses a significant amount of functionality behind a range of JSTL tags. The mobiliser tags provide software functionality that generates the most appropriate output for the end user's device. Key aspects of the mobiliser solution are

Whenever a user connects to a dynamic web page, mobiliser matches the user device type against a large database of device capabilities

Mobiliser generates page content suitable for the end user device whether this is WML, HTML, XHTML or XHTML-Mobile Profile

Mobiliser also dynamically determines certain other device capabilities which are used at a lower level of page content creation

Device capabilities are used in deciding how best to generate page content suitable for the end user device

Mobiliser automatically creates “boilerplate” page headers which are required for the end user device to correctly read and interpret page content

Where a specific device is missing a particular capability required for a page mobiliser will automatically provide a sensible translation

Mobiliser will automatically paginate page content in the case where the end user device has content limitations (primarily relevant to mobile WAP devices)

Mobiliser will automate certain tasks which are commonly required but tedious to do “by hand”—for example this applies to menu creation and image selection

Mobiliser understands traditional HTML page styling and page styling using Cascading Style Sheets (CSS), it will translate to and from CSS according to the end user's device capabilities. CSS is a major platform for the styling of web pages and has been standardised as the future of web page development. The standards organisation W3C recommends page authors style pages using CSS for all new web pages. However, whilst Microsoft Internet Explorer and Netscape Navigator have long term support for CSS for desktop browsers this is not the case with the more primitive HTML browsers in PDAs and many mobile devices.

The mobiliser solution uses as a foundation for its device capabilities an open source device capabilities project called WURFL—Wireless Uniform Resource File (http://wurfl.sourceforge.net). The WUREL project has collected device capabilities from a number of industry experts and the capabilities are maintained within an XML based file. This device capabilities file describes up to around 200 capabilities for nearly 2000 distinct mobile devices and device revisions.

To improve systems performance the mobiliser solution holds the device capabilities in an SQL database rather than the original XML file. As an XML file the WURFL capabilities would have to be read and interpreted each time a page was requested. As an SQL database mobiliser rapidly accesses the relevant data rapidly. Mobiliser also internally caches device details for each user so that the database accesses are needed only initially when the user connects to a mobiliser based page—these are held for the user for around 30 minutes from when they last accessed a mobiliser based page.

Cascading Style Sheet—Inline Style Processing

Mobiliser translates to and from Cascading Style Sheet inline style mechanisms.

### EXAMPLE A

For a table cell:
<mob:td color=“red”>test</mob:td>
   will be output as the following for HTML 3.2 and HTML 4 as these both support the color attribute:
<td color=“red”>test</td>
   and will be output as:

<td style=“{color: red;}”>test</td>

for XHTML Mobile Profile as this doesn't support the color attribute but instead requires CSS

### EXAMPLE B

<mob:td style=“{color:red;}”>test</mob:td>
   will be output as the following for HTML 3.2 (which doesn't support CSS):
<td color=“red”>test</td>
   and will be output as the following for XHTML Mobile Profile as this requires CSS:
<td style=“{color:red;}”>test</td>
   Automatic Pagination

A pagination algorithm is provided within the translation engine so that the content author needs to make no specific decisions themselves about where content is to be kept together or broken apart.

As content is rendered by the software each distinct block of content, as identified by HTML or WML constructs, is first rendered for output, its size is calculated, and the algorithm decides on the way in which the content can be split into pages based on device parameters and content size.

The algorithm ensures that individual HTML/WML constructs are not split apart. E.g all content in a paragraph <p> . . . </p> will be displayed on the same page, as will all content for a table <table> . . . </table>, and this rule is applied to all other constructs.

The content author can elect to mark blocks that should be kept together on a page.

The algorithm decides on the number of pages that will suit a particular user device and generates navigation links as next page/previous page links.

Deep Context Analysis

The paging capability described above is one instance of the mobiliser ability to traverse the hierarchy of a document to determine the best way to output the content.

Whilst many constructs map simply from one device capability to another e.g. paragraphs occur in all the markup languages, there are some major differences.

One example of this is in WAP content where there is the unique concept of division of downloadable content into distinct displayable pages. Such a concept does not exist with HTML and content rendering must insert an appropriate alternative. This is guided by the concept of a compatibility mode which a content author can optionally set and tells the software to either remove a specific feature if it has no direct equivalent, or translate it to features which do exist in the target device.

### EXAMPLE 1

An example of Deep Context Analysis is in WAP WML content where there is a concept of a template which defines standard navigation mechanisms available to all pages in a downloaded “deck” of content. With WML this is clearly quite valid and so is simply output. With HTML there is no equivalent mechanism, the details of the template items are interpreted and stored. When individual “cards” (pages) of information are output now as their HTML equivalents the template items are converted

For example the following original WAP code:

<wml>
<template>
<do type=“accept” label=“next”><go href =“next.jsp”/> </do>
</template>
<card id=“main”>
<p>Mobiliser is a great new piece of technology<br/><br/>
For further information <a href =“#second”>click here</p>
<p>
Press the next option for the next page
</p>
</card>
<card id=“ second”>
<p>Mobiliser works in a JSP environment
</p>
</card>
</wml>

Is translated to HTML as:

<html>
<body>
<p>Mobiliser is a great new piece of technology<br/><br/>
For further information <a href =“#second” >click here</p>
<p>Press the next option for the next page</p>
<a href=“next.jsp”>next</a>
<a name=“second>
<p>Mobiliser works in a JSP environment
</p>
<a href=“next.jsp”>next</a>
</body>
</html>

As can be seen in this example the template cannot be immediately translated to an alternative construct as it can apply to multiple instances. In this example the template must have its equivalent output in each place where a WML card is defined as this is the only way in which it can be correctly emulated.

Deep Context Analysis therefore introduces the concept of understanding document context to apply translations at the right point(s) of output rather than simply sequentially translating a feature from one markup language to another.

This is a key differentiator because this cannot simply be done with sequential transcoding solutions or with XSLT type technologies.

### EXAMPLE 2

Deep Context Analysis does not just apply to content being translated from WML to HTML, it applies in the reverse direction for document forms. HTML creates forms using a specific <form> . . . </form> construct. This does not exist in WML although the same effect is achievable

e.g. the original HTML:

<form action=“submitform.jsp” method=“post”>
<label>name: </label><input id=“name” type=“text”/><br/>
<label>password: </label><input id=“password type=”password”/><br/>
<input type=“submit” label=“Submit”/>
</form>

becomes the following in WML:

<p>name: <input name=“name” type=“text” title=“name:”/><br/>
password: <input name=“password” type=“password”
title=“password:”/><br/>
<go method=“post” href=“submitform.jsp”>
<postfield name=“name” value=“$name”/>
<postfield name=“password” value=“$password”/>
</go>
</p>

This shows that as an HTML form is being converted contextual information is being acquired to allow its WML equivalent to be properly generated

### EXAMPLE 3

### a) HTML Including a Form Element (Original Content)

<!DOCTYPE html PUBLIC “-//W3C//DTD XHTML 1.0
Transitional//EN”
“http://www.w3.org/TR/xhtml1/DTD/xhtml1-transitional.dtd”><html
xmlns=“http://www.w3.org/1999/xhtml” lang=“en”><head>
<meta content=“no-cache” http-equiv=“Cache-Control”/>
<meta content=“max-age=0” http-equiv=“Cache-Control”/>
<meta content=“must-revalidate” http-equiv= “Cache-Control”/>
<title>Form/Fieldset to WML examples</title>
</head>
<body>
<p align=“left”>This is an example of a form conversion to WML
including fieldsets
</p>
<hr />
<hr />
<form action=“testsubmit.jsp” method=“post”>
<input name=“DirectoryQ” type=“hidden” value=“118 000” />
<fieldset title=“About you”>
<label>Firstname</label><input name=“Firstname” type=“text”
/><br/>
<label>Lastname</label><input name=“Lastname” type=“text” /><br
/>
</fieldset>
<fieldset title=“Security”>
<label>Secret</label><input name=“Secret” type=“password” /><br
/>
</fieldset>
<input name=“ remember” type=“checkbox”>Remember
me</input><br />
<input name=“optin” type=“checkbox”
checked=“checked”>Please
send me updates</input><br />
<input name=“Send” type=“submit” value=“Submit Form” />.
<input type=“reset” value=“Reset Form” />
</form>
<hr />
<ul>
<li><a href=“forms.jsp”>Return to forms examples menu</a></li>
<li><a href=“../index.jsp”>Return to main menu</ax></li>
<li><a href=“../demomain.jsp”>SlipStream demonstrations</a></li>
</ul>
</body>
</html>

### b) WML (Translated Content)

### Equivalent Elements

<?xml version=“1.0”?><!DOCTYPE wml PUBLIC “-//WAPFORUM//DTD WML
1.1//EN” “http://www.wapforum.org/DTD/wml_1_1.dtd”><wmlx><head>
<meta content=“no-cache” forua=“true” http-equiv=“Cache-Control”/>
<meta content=“max-age=0” forua=“true” http-equiv=“Cache-Control”/>
<meta content=“must-revalidate” forua=“true” http-eguiv=“Cache-Control”/>
</head>
<card>
<p align=“left”>This is an example of a form conversion to WML including fieldsets
</p>
<do type=“accept” label=“Submit Form”>

| | |
|---|---|
| <go | href=“testsubmit.jsp?Send=Submit+Form” |

method=“post”><postfield name=“DirectoryQ” value=“118+000”/>
<postfield name=“Firstname” value=“$(Firstname:e)”/>
<postfield name=“Lastname” value=“$(Lastname:e)”/>
<postfield name=“Secret” value=“$(Secret:e)”/>
<postfield name=“remember” value=“$(remember:e)”/>
<postfield name=“optin.” value=“$(optin:e)”/>
</go></do>
<p>
<fieldset title=“About you”>
Firstname<input type=“text” name=“Firstname” /><br />
Lastname<input type=“text” name=“Lastname” /><br />
</fieldset>
<fieldset title=“Security”>
Secret<input type=“password” name=“Secret” /><br />
</fieldset>
Remember me<select name=“remember” ivalue=“2”><option
value=“1”>On</option><option value=“0”>Off</option></select><br/>
Please send me updates<select name=“optin” ivalue=“1”><option value=“1”>
On</option><option value=“0”>Off</option></select><br/>
<anchor title=“Submit Form”>

| | |
|---|---|
| <go | href=“testsubmit.jsp?Send=Submit+Form” |

method=“post”><postfield name=“DirectoryQ” value=“118+000”/>
<postfield name=“Firstname” value=“$(Firstname:e)”/>
<postfield name=“Lastname” value=“$(Lastname:e)”/>
<postfield name=“Secret” value=“$(Secret:e)”/>
<postfield name=“remember” value=“$(remember:e)”/>
<postfield name=“optin” value=“$(optin:e)”/>
</go>Submit Form</anchor><br/>
<anchor title=“Reset Form”><refresh><setvar name=“Firstname” value=“”/>
<setvar name=“Lastname” value=“”/>
<setvar name=“Secret” value=“”/>
<setvar name=“remember” value=“”/>
<setvar name=“optin” value=“1”/>
</refresh>Reset Form</anchor><br/>
</p>
<p mode=“nowrap”><select>
<option onpick=“forms.jsp”>Return to forms examples menu</option>
<option onpick=“../index.jsp”>Return to main menu</option>

| | |
|---|---|
| <option | onpick=“../demomain.jsp”>SlipStream |

demonstrations</option>
</select></p>
</card>
</wml>

### EXAMPLE 4

### a) Document for HTML 3.2 with no Support for CSS but Use of Style Attributes

<!DOCTYPE html PUBLIC “-//W3C//DTD XHTML 1.0
Transitional//EN”
“http://www.w3.org/TR/xhtml1/DTD/xhtml1-transitional.dtd”><html
xmlns=“http://www.w3.org/1999/xhtml” lang=“en”><head>
<meta content=“no-cache” http-equiv=“cache-control”/>
<title>F u c h s i a</title>
</head>
<body link=“white” vlink=“white” alink=“white” text=“white”
bgcolor=“black”>
<h2><font color=“#ff0099”>Let your senses be
seduced</font></h2>
<p align=“center”><img alt=“Fuchsia logo” src=“images/Fuchsia-
NewLogo.gif” />
</p>
<h2>tempt ... taste ... indulge</h2>
<div>
<a href=“Restaurant.jsp”><img alt=“Restaurant/Bar” border=“0”
src=“images/Resturant.gif” /></a>
</div>
<div>
<a href=“Lounge.jsp”><img alt=“Lounge/Club” border=“0”
src=“images/LoungeClub.gif” /></a>
</div>
<div>
<a href=“Contact.jsp”><img alt=“ContactUs” border=“0”
src=“images/contact.gif” /></a>
</div>
<div>
<a href=“#”><img alt=“home” border=“0”
src=“images/home_Over.gif” /></a>
</div>
<hr />
<i>This site has been developed using <a
href=“http://www.mobile-life.com”>SlipStream</a>
<sup>(tm)</sup>
technology from Mobile Life</i>
</body>
</html>

1. Notes
In HTML 3.2 there is no support for CSS
Font colour can be over-ridden using the font element
General page attributes such as the colour of text and links can be set using attributes of the body tag
Alignment of paragraphs can be set using the align attribute

### b) Document Using HTML V4 Supporting CSS and Style Attributes

<!DOCTYPE html PUBLIC “-//W3C//DTD XHTML 1.0
Transitional//EN”
“http://www.w3.org/TR/xhtml1/DTD/xhtml1-transitional.dtd”><html
xmlns=“http://www.w3.org/1999/xhtml” lang=“en”><head>
<meta content=“no-cache” http-equiv=“cache-control”/>
<title>F u c h s i a</title>
</head>
<body link=“white” vlink=“white” alink=“white” text=“white”
bgcolor=“black”>
<h2 style=“color:#ff0099; text-align:center”>Let your senses be
seduced</h2>
<p align=“center”><img alt=“Fuchsia logo” src=“images/Fuchsia-
NewLogo.gif” />
</p>
<h2>tempt ... taste ... indulge</h2>
<div>
<a href=“Restaurant.jsp”><img alt=“Restaurant/Bar” border=“0”
src=“images/Resturant.gif” /></a>
</div>
<div>
<a href=“Lounge.jsp”><img alt=“Lounge/Club” border=“0”
src=“images/LoungeClub.gif” /></a>
</div>
<div>
<a href=“Contact.jsp”><img alt=“ContactUs” border=“0”
src=“images/contact.gif” /></a>
</div>
<div>
<a href=“#”><img alt=“home” border=“0”
src=“images/home_Over.gif” /></a>
</div>
<hr />
<i>This site has been developed using <a
href=“http://www.mobile-life.com”>SlipStream</a>
<sup>(tm)</sup>
technology from Mobile Life</i>
</body>
</html>

2. Notes
In HTML 4 there is support for CSS so this can be mixed with other style attributes
Font colour and paragraph alignment can be set using CSS
General page attributes such as the colour of text and links can be set using attributes of the body tag

### C) Document Using XHTML-Mobile Profile which Requires Use of CSS and does not Support Separate Styling Attributes

<?xml version=“1.0”?><!DOCTYPE html PUBLIC
“-//OPENWAVE//DTD
XHTML Mobile 1.0//EN” “http://www.openwave.com/DTD/xhtml-
mobile10.dtd”><html xmlns = “http://www.w3.org/1999/xhtml”
xmlns:wml=“http://www.wapforum.org/2001/wml”
xml:lang=“en”><head>
<meta content=“no-cache” http-eguiv=“cache-control”/>
<title>F u c h s i a</title>
<style>
A:link {color:white;}
A:visited {color:white;}
A:active {color:white;}
</style>
</head>
<body style=“{color:white;background-color:black;} ”>
<h2 style=“color:#ff0099; text-align:center”>Let your senses be
seduced</h2>
<p style=“{text-align:center;} ”>
<img alt=“Fuchsia logo” src=“images/Fuchsia-NewLogoshort.gif” />
</p>
<h2>tempt ... taste ... indulge</h2>
<div>
<a href=“Restaurant.jsp”>Restaurant/Bar</a>
</div>
<div>
<a href=“Lounge.jsp”>Lounge/Club</a>
</div>
<div>
<a href=“Contact.jsp”>ContactUs</a>
</div>
<div>
<a href=“#”>home</a>
</div>
<hr />
<i>This site has been developed using <a
href=“http://www.mobile-life.com”>SlipStream</a>
<b><small>(tm)</small></b> technology from Mobile Life</i>
</body>
</html>

3. Notes
In XHTML Mobile Profile (as with strict XHTML) CSS is the specified mechanism for document styling rather than the use of styling elements (like <font>) and element style attributes
Style elements and attributes are converted both to inline CSS
Former general page styling attributes are converted to CSS both in the head section of the document and in the body tag itself
Font colour and paragraph alignment can be set using CSS

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of providing content to be presented on a terminal, said method comprising:
taking as an input a first document in a first document language, the first document language using markup tags to define elements of the document, said first document language including a first set of element types,
translating the first document into a second document in a second document language, the second document language using markup tags, text or document codings to define elements of the second document, said second document language including a second set of element types,
wherein the first set of element types includes a first element type, for which an equivalent element type is not present in said second set, and wherein the first document includes a section including said first element type and at least one attribute of the element type,
the method comprising processing said first section in the first document, and generating a corresponding second section in said second document, said second section including a second element type,
wherein one of said first section and said second section includes two separate subsections which each include one or more attributes corresponding to one or more attributes of said second or said first element type, respectively.

2. A method according to claim 1, wherein said two separate subsections are at the same level of hierarchy in said document.

3. A method according to claim 1, wherein said two different subsections are at different levels of hierarchy in said document.

4. A method according to claim 3, wherein said second section includes two or more separate subsections which each include one or more attributes corresponding to one or more attributes of said first element type.

5. A method according to claim 4, wherein said second section includes two or more separate subsections which each include the same attribute, said same attribute corresponding to an attribute of the first element type.

6. A method according to claim 5, wherein said first section includes a first subsection including a template element and a plurality of further subsections defining parts of a document to be presented separately on the user terminal.

7. A method according to claim 6, wherein said second section includes a plurality of equivalent subsections corresponding to each of said further subsections, said equivalent subsections each including the same attribute, said same attribute corresponding to an attribute of said template element.

8. A method according to claim 7, wherein said template element type has a hyperlink attribute defined therein, and wherein said same attribute is a corresponding hyperlink attribute.

9. A method according to claim 4, wherein the wherein said second section includes two separate subsections which each include one or more different attributes, said different attributes each corresponding to at least one attribute of said first element type.

10. A method according to claim 9, wherein said first element type is a form element type.

11. A method according to claim 10, wherein said two separate subsections of said second section include a first subsection in which the presentation of input data fields is defined and a second subsection in which an action is defined whereby the data collected in said input data fields is sent a server.

12. A method according to claim 1, wherein said two separate subsections are in the first document and the second document includes one section which is equivalent to one of the two separate subsections.

13. A method according to claim 1, wherein the first set of element types includes attributes which do not exist in the second set of element types and wherein the translation is conducted using equivalent expressions using Cascading Style Sheet attributes.

14. A method according to claim 1, wherein the first set of element types includes attributes containing Cascading Style Sheet expressions which do not exist in the second set of element types and wherein the translation is conducted using equivalent expressions using element attributes.

15. A method according to claim 1, wherein the first set of element types includes attributes containing Cascading Style Sheet expressions which do not exist in the second set of element attributes and wherein the translation is conducted using equivalent expression using elements and attributes.

16. A method according to claim 1, wherein the first set of element types, attributes and document content is converted to a second set of element types, attributes and document content according to specific real-time and pre-determinable capabilities of that device.

17. A method according to claim 1, wherein the generation of a second document is partitioned into sections to enable operation with devices with limited bandwidth connections or memory limitations.

18. A method according to claim 17, where there is generation of navigational elements allowing a user to select different sections of the equivalent of the first document.
